(19) United States
(12) Patent Application Publication
(10) Pub. No.: US 2012/0325621 A1
(43) Pub. Date: Dec. 27, 2012

(54) Bulk Product Diverter

(75) Inventors: Adam Koller, Minneapolis, MN (US); Scott Thompson, White Bear Lake, MN (US)

(73) Assignee: DELKOR SYSTEMS, INC., Circle Pines, MN (US)

(21) Appl. No.: 13/530,475

(22) Filed: Jun. 22, 2012

Related U.S. Application Data
(60) Provisional application No. 61/500,938, filed on Jun. 24, 2011.

(51) Int. Cl. B65G 47/46; B65G 19/14

(52) U.S. Cl. 198/367; 198/716

(57) ABSTRACT

A bulk product diverter and system for separating bulk product units into multiple product streams includes a unique conveyor assembly. The conveyor has a plurality of flights wherein the adjacent flights define buckets into which groups of bulk product units are placed. The conveyor conveys each bucket in a downstream direction along a horizontal path, then along a vertical path, then around a turn of approximately 150 degrees. A diverter fence is selectively movable between an open position and a closed position. In the open position the path defines a first gate through which acceptable product units are passed. In the closed position the product units continue around the turn to pass through a second gate.

### CROSS-REFERENCE TO RELATED APPLICATIONS

The present application is a utility filing, and claims priority to, previously filed Provisional patent application No. 61/500,938; which was filed on Jun. 24, 2011. The entire content of Provisional patent application No. 61/500,938 is incorporated herein by reference.

### BACKGROUND OF THE INVENTION

1. Field of the Invention

This disclosure is directed to embodiments of a bulk product diverter (or sorting array) which is configured to sort bulk product into multiple product streams. More specifically, in at least one embodiment the array is configured to divert buckets of conveyed product into acceptable and unacceptable streams using a actuatable fence to provide gate openings corresponding to the respective streams.

2. Description of the Related Art

Bulk loader assemblies which allow product to be conveyed along a production or packaging line and be separated are known. Such assemblies however, tend to have several drawbacks. For example, many rely heavily on pneumatic actuation and thus tend to be fairly noisy and require significant air consumption to perform. Such pneumatic based assemblies often utilize “bomb-bay” loading solutions which can result in premature component wear. Such assemblies may also be prone to jamming as they lack the ability to precisely match the speed and position of the product flight as it flows along the conveyor.

It is thus an object of this disclosure to provide a bulk product diverter that enables consecutive bulk product that is arranged in flights to be separated into two product streams using a more efficient and reliable mechanism than prior pneumatic based assemblies.

In the embodiments disclosed herein, a bulk product diverter is shown and described, and which provides significant improvement over existing loader assemblies. Some key features of the product diverter disclosed herein is the unique ability of the diverter to select between two product flow streams (A and B or acceptable and unacceptable, etc.) using a servo gear motor driven (rather than pneumatically) fence which orbits around a turn of the conveyer path to alternatingly define two gates through which the product streams are directed. The fence motion is coordinated with the conveyor flight velocity and position to ensure that they are speed- and position-matched.

Additional details of the summarized embodiments of the invention and/or additional embodiments of the invention may be found in the Detailed Description of the Invention below and are illustrated in the accompanying figures.

### BRIEF DESCRIPTION OF THE SEVERAL VIEWS OF THE DRAWING(S)

A detailed description of the invention is hereafter described with specific reference being made to the drawings.

FIG. 1 is a perspective view of an embodiment of the invention.

FIG. 2 is a partial side view of the embodiment shown in FIG. 1 depicting the diverter fence in the closed position across gate “A”.

FIG. 3 is a partial side view of the embodiment shown in FIG. 1 depicting the diverter fence in the open position of gate “A”

FIGS. 4-9 are close up perspective views of the embodiments shown in FIGS. 1 and 3, depicting the actuation of the diverter fence, to open and close gate “A” as the conveyor advances a flight of product.

### DETAILED DESCRIPTION OF THE INVENTION

For the purposes of this disclosure, like reference numerals in the figures shall refer to like features unless otherwise indicated.

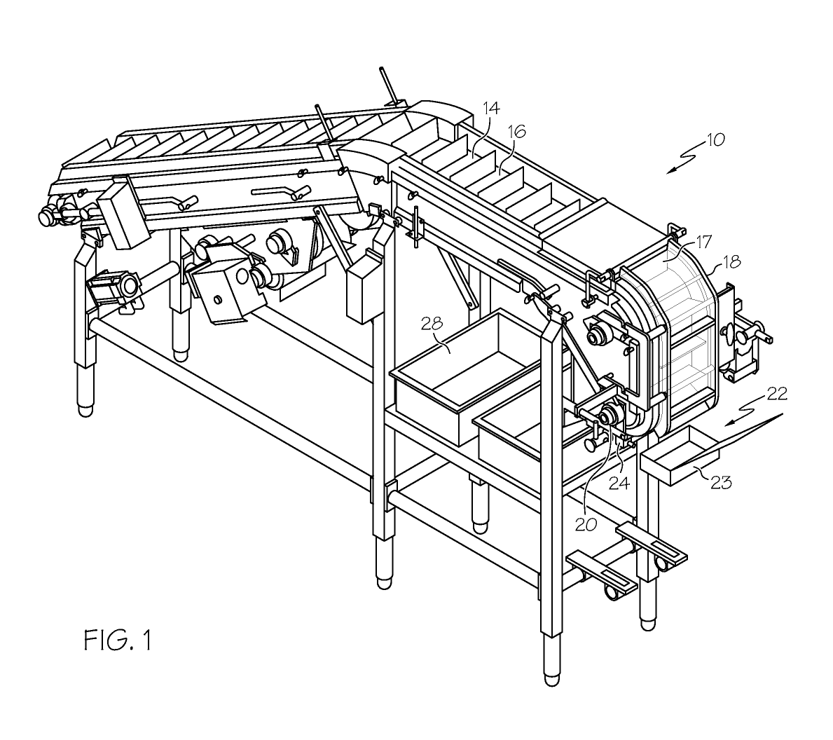

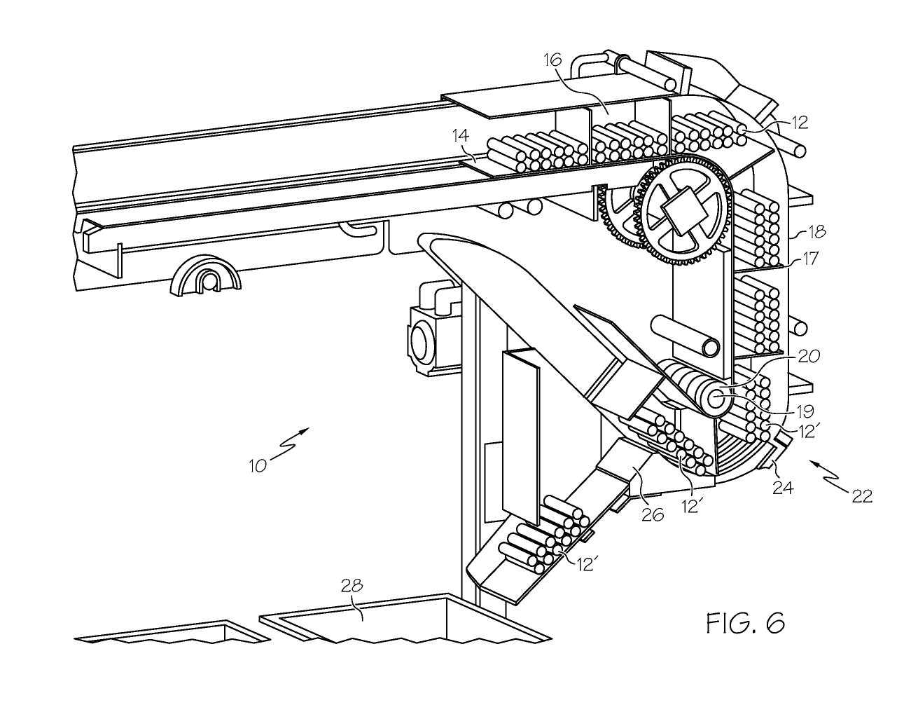

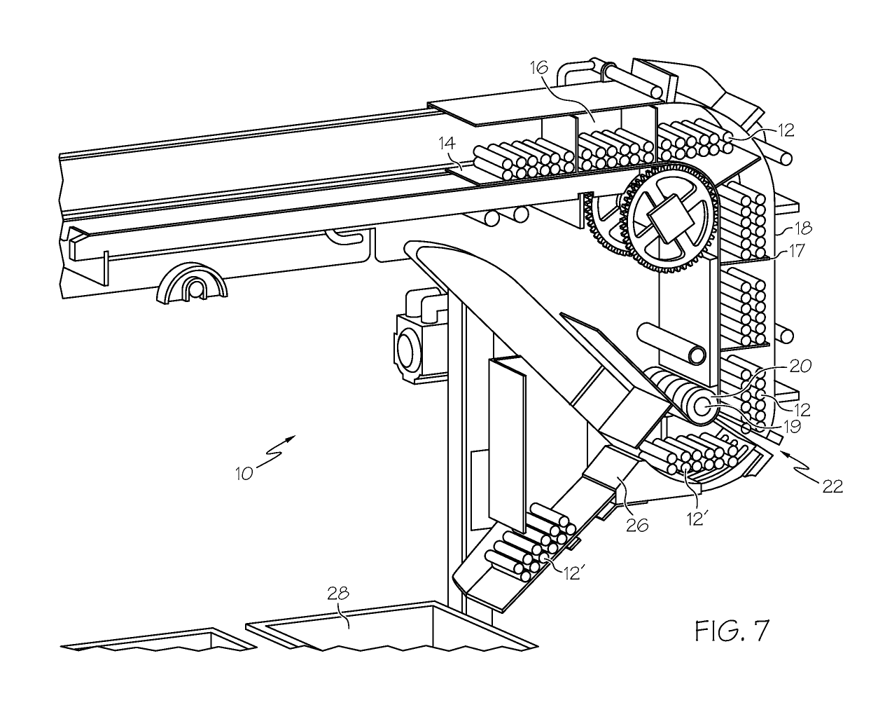

As is shown in the various FIGS. 1-9 a bulk product diverter 10 is shown. The diverter 10 depicted herein can be a part of any industrial line (e.g. manufacturing, assembly, packaging, etc.) wherein it is necessary or desired to separate bulk units of product into multiple product streams. For example, where the diverter 10 is part of a packaging line, bulk product 12 (not shown in FIG. 1) that is arranged along the pleated conveyor 14 can be selectively and/or automatically diverted from a primary or acceptable product stream “A” (wherein, for example, the product 12 advances on to be packaged for shipping) to a secondary or unacceptable product stream “B” without the need to shut down or otherwise interrupt the packaging line.

In order to do this, the diverter 10 utilizes a pleated conveyor 14, which includes pleats or flights 17, wherein adjacent flights 17 define buckets 16 that are configured to contain a quantity of bulk product 12. The buckets 16 are advanced in a downstream direction along the conveyor, typically along a horizontal path or plane, whereupon the conveyor turns substantially 90 degrees causing the buckets 16 to segue from being advanced along a horizontal path/direction to a vertical (downward) path/direction. It must be noted that in the various industrial applications which the diverter 10 may be used, it will be recognized and understood that the terms horizontal and vertical are mere approximations. For the diverter 10 to function as desired it is necessary only that the bulk product 12 rest against the foremost flight 17 of the bucket 16 as a function of gravity, such that if the flight 17 were removed (or re-directed as shall be discussed in greater detail below) the product 12 would continue moving in a downward direction.

Where the conveyor 14 transitions from a substantially horizontal to a substantially vertical orientation, the diverter 10 includes a cover 18 that is positioned outward from the conveyor flights 17 at a distance corresponding to the height of the flights 17 or just beyond. This allows the conveyor 14 to run smoothly under the cover 18 while the relative position of the flights 17 and the cover 18 contain the bulk product 12 within their respective buckets 16 without unduly disturbing the position of the product 12 or allowing the product 12 to interfere with the advancement of the conveyor 14.

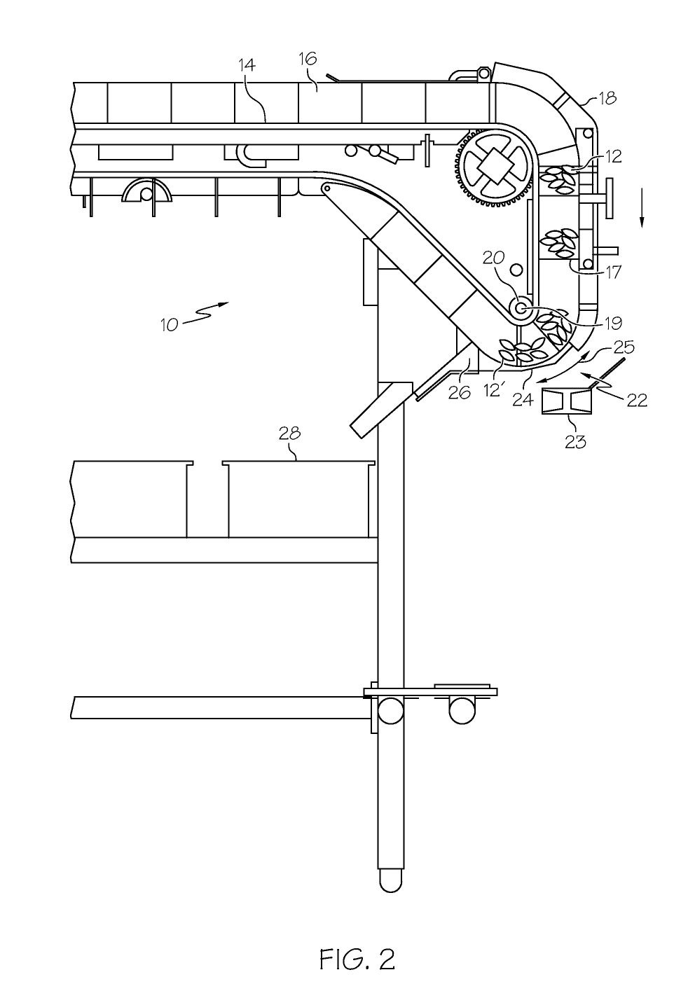

The conveyor 14 advances each bucket 16 downstream along the vertically downward path shown in FIGS. 2-9, for any distance sufficient to allow the product 12 to rest (as a function of gravity or momentum) against the foremost flight 17 of the bucket 16. Then the conveyor 14 turns approximately 150 degrees around a servo 19 driven nose roller 20. The nose roller 20 is relatively small compared to the length of each flight 17. In at least one embodiment the roller 20 has a diameter of about 2 inches (˜50-52 mm) and thus a radius of about 1 inch (23-26 mm), whereas each flight 17 has a height of about 3 inches (˜75-77 mm). In at least one embodiment the radius of the roller 20 versus the height of the flight 17 is a ratio of 1:3. In at least one embodiment the ratio is about 1:4.

The relatively small diameter of the roller 20 allows the flight 16 to accelerate away from the product 12, which allows the product 12 to fall thru a gate “A” 22 and into a carton or other area 23

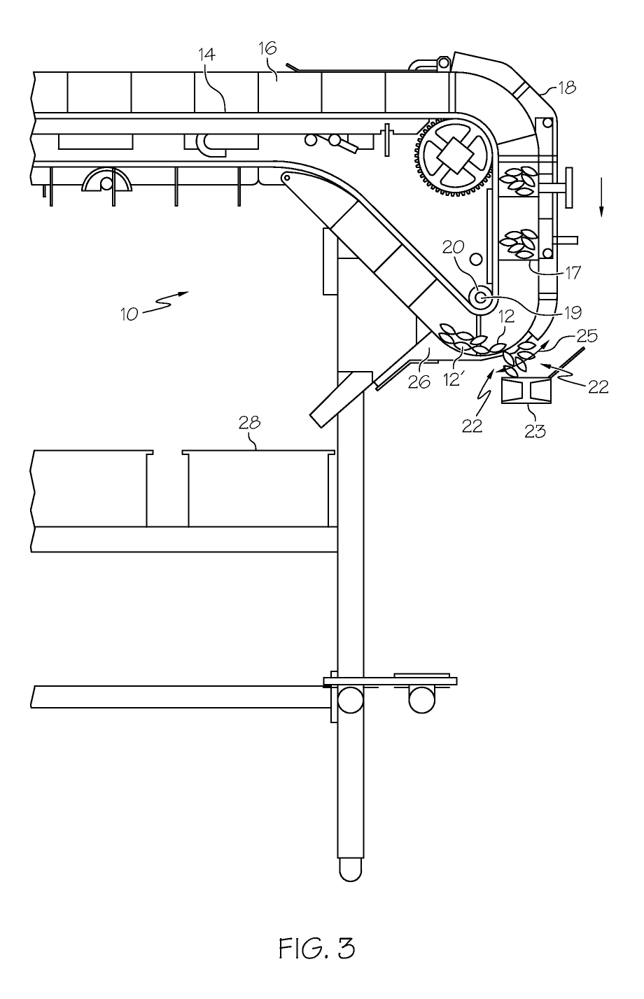

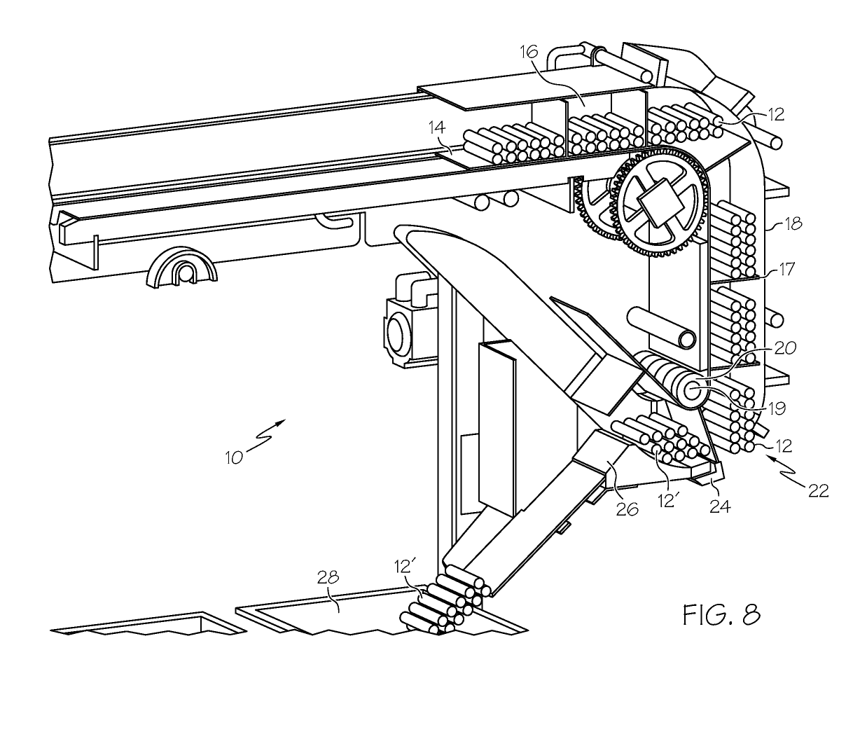

Gate “A” 22 is an opening provided by a diverter fence 24 when the diverter fence 24 is in the open or retracted position. The open position is depicted in FIGS. 3, 4 and 9, and partially open in FIG. 8.

In some embodiments, it is desirable to allow the product units 12 to accumulate prior to passing through the Gate “A”. In order to accomplish this, as a bucket 16 of product approaches the roller 20 but before the bucket 16 is advanced around the turn (as discussed above) the diverter fence 24 is held in the closed position across the Gate “A” 22 to allow the product 12 to collect (via gravity) against the diverter fence 24. Then, as the foremost flight 17 of the bucket 16 in question begins to round the roller 20, the diverter fence 24 is quickly opened in a shearing fashion to meter the product 12 out through gate “A” 22 as a potentially more uniform mass of product units 12 and not as a flowing plurality of product units.

As a result of using the diverter fence 24 in this way the product units 12 effectively fall from a lower point (less potential energy and “bounce” in the carton) and they will be organized in one neater pile. The snapping motion of the diverter fence 24 does not disrupt the product units 12. Because this arrangement allows the product units 12 to fall from a lower point in the system and maintain greater cohesion load times are improved and the diverter system 10 can index faster.

As is shown in the FIGS. 2-9, a second product stream is provided by gate “B” 26, which is positioned about 30 degrees apart from the bottom of the 150 degree turn. Gate “B” 26 is by default open to allow product 12 that is not allowed to pass through Gate “A” 22 to be bulk loaded, removed from the product stream or simply separated from the product exiting through gate “A” 22 as desired. In the embodiment shown in the figures gate “B” is configured to place product 12 into a bin 28 or other container, package or area.

Because gate “B” is downstream from gate “A”, product 12 from a given bucket 16 can only advance to and through gate “B” by passing across gate “A” when the diverter fence 24 is in the closed position shown in FIGS. 2, 5, 6 and 7.

The diverter fence 24 is, in at least one embodiment, driven by a servo gear motor that swings in an orbital manner between gate “A” 22 and gate “B” 26 around the center of the nose roller 20 and flights 17. The motion of the fence 24 (depicted by arrows 25 in FIGS. 2 and 3) is coordinated with the motion of the conveyor flight velocity and position. This coordination can be achieved by a variety of mechanisms, but in at least one embodiment, the coordinated movement is provided by using servo technology to electrically “cam” the two drives together so they are speed and position matched.

It should be recognized as well that this relationship also allows the diverter 10 to be used in an index function as well.

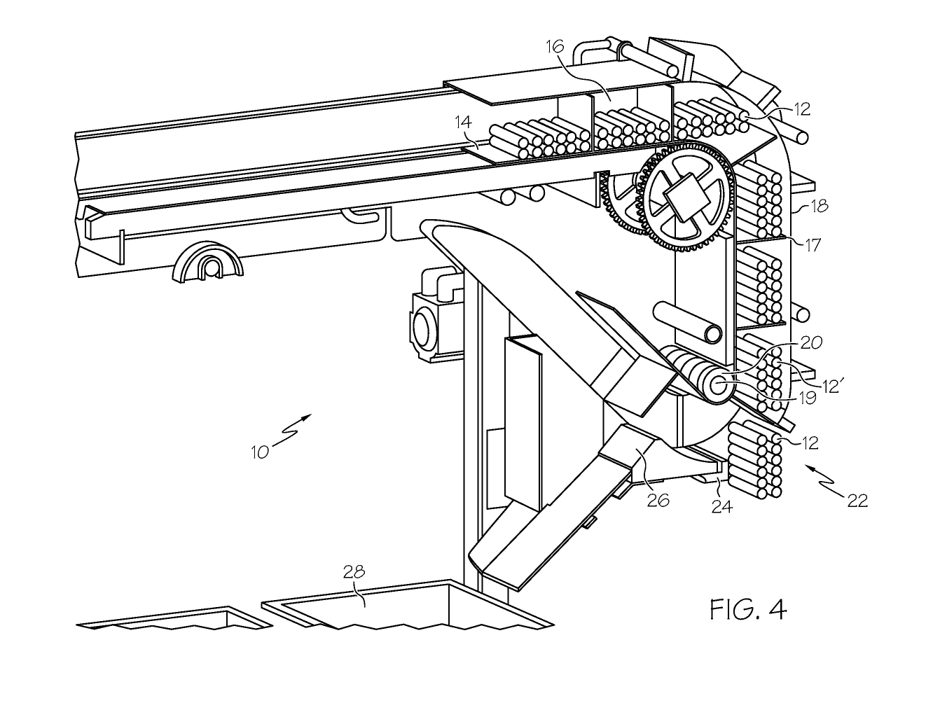

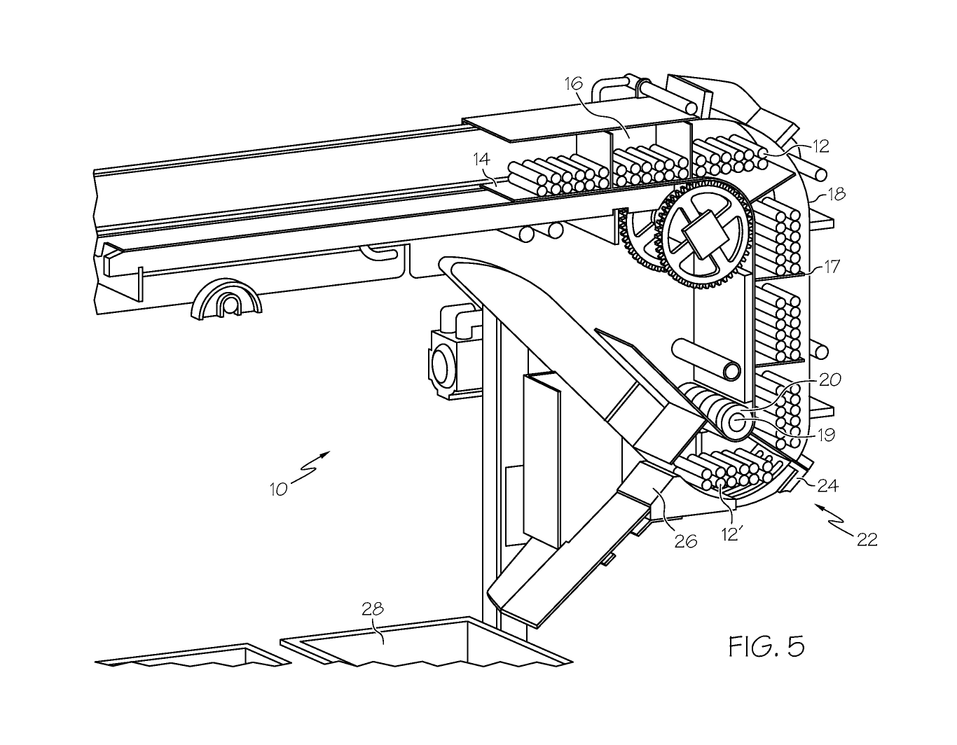

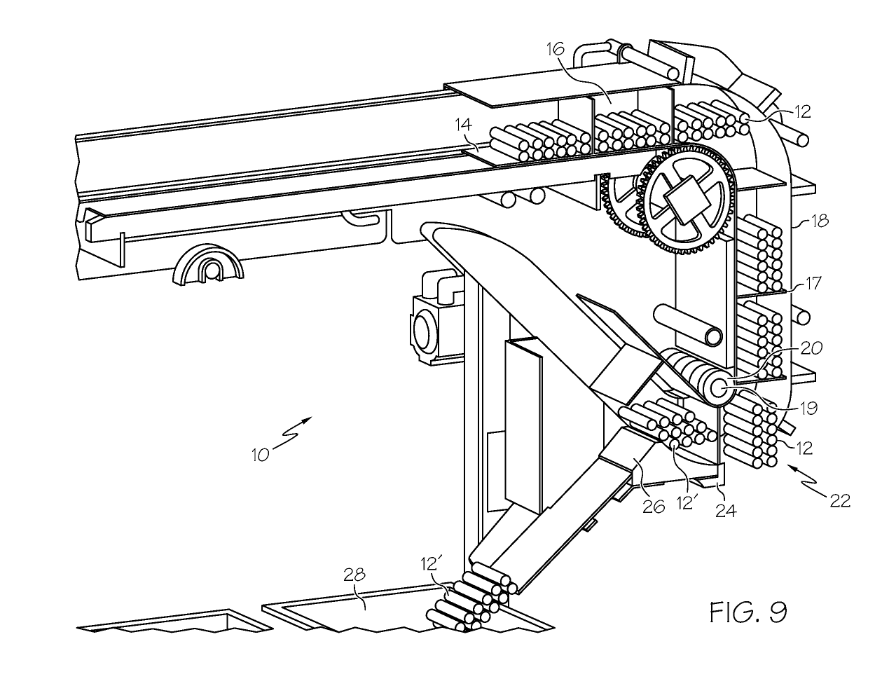

The decision to open or close gate “A” 22 can be made automatically and/or as a function of any of a variety of sensors or at operator discretion (not shown) in communication with the servo controlling the diverter fence 24. For example an optical, weight, or other type of sensor may detect some unacceptable variance in the product 12′ shown in FIG. 4. As a consequence, a signal is sent from the sensor to the servo controlling the diverter fence 24. This signal can cause the fence 24 to be moved across gate “A” 22 thereby placing it in the closed position (shown in FIGS. 5-7), while the advancing flight 17 will sweep the unacceptable product 12′ to and thru gate “B” such as is shown in FIG. 3. The diverter 10 may then automatically reset the diverter fence 24 to the open position after the unacceptable product 12′ is past gate “A”, or a sensor (the same or different sensor mentioned above) can detect when subsequent acceptable product is approaching gate “A” and then return the fence 24 to the open position such as is illustrated in FIGS. 8 and 9.

The above disclosure is intended to be illustrative and not exhaustive. This description will suggest many variations and alternatives to one of ordinary skill in this art. The various elements shown in the individual figures and described above may be combined or modified for combination as desired.

What is claimed is:

1. A bulk product diverter comprising:
a conveyor, the conveyor having a plurality of flights, adjacent flights defining a bucket, the conveyor constructed and arranged to advance each bucket in a downstream direction along a horizontal path, then along a vertical path, then around a turn of approximately 150 degrees.
a diverter fence, the diverter fence being selectively movable between an open position and a closed position, the diverter fence being positioned adjacent to the turn.

2. The bulk product diverter of claim 1, further comprising a cover, the cover positioned over at least the vertical path of the conveyor.

3. The bulk product diverter of claim 1, wherein each flight has a height, the height being about 3 inches.

4. The bulk product diverter of claim 1, wherein the turn comprises a roller, the roller having a radius, the radius being about 1 inch.

5. The bulk product diverter of claim 1 wherein each flight has a height and the turn comprises a roller, the roller having a diameter, the radius of the roller versus the height of the flight being a ratio of 1:3

6. The bulk product diverter of claim 1 wherein the conveyor comprises a first gate and a second gate, the first gate being defined by the diverter fence in the open position.

7. The bulk product diverter of claim 6 wherein the second gate is positioned downstream of the diverter fence within the turn of 150 degrees.

8. A system for separating bulk units of product into multiple product streams without interruption comprises:
a bulk product diverter having a conveyor, the conveyor having a plurality of flights, adjacent flights defining a bucket, a plurality of product units being placed into each bucket, the conveyor constructed and arranged to advance each bucket of product units in a downstream direction along a horizontal path, then along a vertical path, then around a turn of approximately 150 degrees.
a diverter fence, the diverter fence being selectively movable between an open position and a closed position, the diverter fence being positioned adjacent to the turn.

9. The system of claim 8 wherein the conveyor comprises a first gate and a second gate, the first gate being defined by the diverter fence in the open position.

10. The system of claim 9 wherein the second gate is positioned downstream of the diverter fence within the turn of 150 degrees.

11. The system of claim 10 further comprising at least one sensor, the at least one sensor being in communication with the diverter fence, the at least one sensor constructed and arranged to determine if the bulk product units within each bucket are acceptable or unacceptable.

12. The system of claim 11 wherein when the sensor senses that the bulk product units within one of the buckets are acceptable the diverter fence is placed in the open position to allow the acceptable bulk product units to pass through the first gate.

13. The system of claim 12 wherein the bulk product units accumulate against the diverter fence before the diverter fence is placed in the open position.

14. The system of claim 12 wherein when the sensor senses that the bulk product units within one of the buckets are unacceptable the diverter fence is placed in the closed position to allow the unacceptable bulk product units to convey around the turn and through the second gate.
